(19) United States
(12) Patent Application Publication
(10) Pub. No.: US 2021/0268851 A1
(43) Pub. Date: Sep. 2, 2021

(54) METHOD FOR DETECTING A FAULTY ARRANGEMENT OF A SENSOR MODULE IN A SENSOR MODULE HOLDER IN A TYRE MONITORING SYSTEM OF A VEHICLE AND TYRE MONITORING SYSTEM

(71) Applicant: Continental Automotive GmbH, Hannover (DE)

(72) Inventors: Parthiv Dharamshi, Regensburg (DE); Matthias Kretschmann, Wenzenbach (DE); Shichao You, Regensburg (DE); Michael Löffler, Zeitlarn (DE)

(21) Appl. No.: 17/258,206

(22) PCT Filed: Jul. 3, 2019
(86) PCT No.: PCT/EP2019/067796

§ 371 Date: Jan. 6, 2021

(30) Foreign Application Priority Data
Jul. 6, 2018 (DE) 10 2018 211 211.8

(51) Int. Cl. B60C 23/04

(52) U.S. Cl. CPC B60C 23/0481; B60C 23/0493

(57) ABSTRACT

Disclosed are a method and a system for detecting a faulty arrangement of a sensor module in a sensor module holder in a tire of a vehicle equipped with a tire monitoring system. The detection of a faulty arrangement of a sensor module may be performed by ascertaining on the basis of a comparison of the operating parameters determined by the sensor modules of the tire monitoring system that there is for this sensor module a discrepancy, dependent on a speed of the vehicle, between the operating parameter and an operating parameter to be expected for this sensor module.

The present invention relates to the field of tire monitoring systems in vehicles fitted with tires.

Tire monitoring systems are used for example in modern motor road vehicles (for example cars, trucks, etc.) and typically comprise multiple sensor modules arranged in a respective sensor module holder of a respective tire of the vehicle, which respectively determine in dependence on at least one sensor-detected variable (for example pressure, temperature, acceleration, etc.) at least one operating parameter of the tire in question (for example tire pressure, tire temperature, etc.) and send it by radio to a receiving and evaluating device arranged in the vehicle.

The radio transmissions, mostly in the form of digital data messages, usually take place from time to time, according to a transmission strategy defined in the sensor modules.

One of the sensor-detected variables for example can be used here directly as an operating parameter, which for the variables pressure and temperature for example is useful in order to transmit corresponding tire operating parameters “tire pressure” or “tire temperature” to the receiving and evaluating device arranged in the vehicle.

By contrast, an acceleration detected by the sensors of sensor modules (for example a radial acceleration) is typically not used as such as an operating parameter to be transmitted, but instead the sensor modules determine on the basis of an evaluation of a variation over time of the acceleration, and if necessary taking into account one or more other variables, one or more operating parameters which, though they depend on the detected acceleration, do not represent this acceleration as such.

For example, the rotational speed of the vehicle wheel or vehicle tire in question is often determined in this way from the sensor-detected acceleration and included as an operating parameter in the data transmissions.

In addition, it is possible for example to determine in dependence on the sensor-detected acceleration an operating parameter which is representative of a length of a tire contact area of the tire in question, which is often also referred to as the footprint.

The sensor module holders arranged in the individual tires advantageously allow a sensor module to be easily exchanged at a later time, for example in the event of a defect of the sensor module or in the event of an exhausted electrical battery of the sensor module.

When using such sensor module holders, it has been found that a faulty (for example slightly tilted) arrangement of a sensor module in a sensor module holder can in particular significantly falsify the result of a sensor-based detection of an acceleration. As a result, in principle all of the operating parameters determined in dependence on the detected acceleration can then also be falsified.

It is an object of the present invention to improve the reliability of a tire monitoring system with regard to a faulty arrangement of a sensor module in the sensor module holder in question.

The stated object is achieved by a method according to claim 1 and a tire monitoring system according to claim 9. The dependent claims are aimed at advantageous developments of the invention.

A first aspect of the invention relates to a method for detecting a faulty arrangement of a sensor module in a sensor module holder in a tire of a vehicle equipped with a tire monitoring system, the tire monitoring system having multiple sensor modules arranged in a respective sensor module holder of a respective tire of the vehicle, which respectively determine in dependence on a sensor-detected acceleration at the arrangement location of the sensor module an operating parameter of the tire in question and send it wirelessly to a receiving and evaluating device arranged in the vehicle, with a detection of a faulty arrangement of a sensor module of the multiple sensor modules in the sensor module holder in question being performed by ascertaining on the basis of a comparison of the operating parameters determined by the sensor modules that there is for this sensor module a discrepancy, dependent on a speed of the vehicle, between the operating parameter and an operating parameter to be expected for this sensor module.

The basic concept of the invention is therefore to detect a faulty arrangement of a sensor module.

As already explained, a detection of a faulty arrangement of one of the sensor modules in the sensor module holder in question can be achieved by ascertaining on the basis of a comparison of the operating parameters determined by the sensor modules in dependence on the sensor-detected accelerations at the arrangement locations of the sensor modules that there is for this sensor module a discrepancy, dependent on the speed of the vehicle, between the operating parameter and an operating parameter to be expected for this sensor module when it is properly arranged in the sensor module holder.

A faulty arrangement of a sensor module means here and in the following that the sensor module is not fixed in the tire in the intended position and/or intended orientation by the sensor module holder.

This may be for example the rather unlikely case in practice of a loose, i.e. movable holder, or for example the more likely case of a more or less stable, but incorrectly positioned and/or oriented holder. In particular, the method according to the stated aspect of the invention can be used to detect a sensor module installed tilted in the sensor module holder.

For most incorrect arrangements relevant in practice it has been found that consequent falsifications of the at least one operating parameter based on the detected acceleration (i.e. a discrepancy with respect to the operating parameter to be expected) show a dependence on the current speed of the vehicle. Therefore, the stated ascertainment of a discrepancy dependent on the speed of the vehicle has a particularly high informational value with regard to the incorrect arrangement to be detected.

One reason for the speed dependence of the discrepancy of the determined operating parameter may be that the centrifugal force acting speed-dependently on the sensor module and the sensor module holder together with a mostly high flexibility of typical tire materials (for example rubber) and/or of a sensor module holder often also made of rubber or the like correspondingly influences the position and/or orientation of the incorrectly arranged sensor module, i.e. changes it speed-dependently.

In particular in this regard, the stated method is particularly advantageous if the sensor module holders are respectively designed as a receptacle formed from an elastic material (rubber or the like) for inserting the respective sensor module.

The receptacle may for example delimit an at least approximately cylindrical receiving space, into which a sensor module with an overall or at least partially appropriately dimensioned cylindrical shape can accordingly be inserted. The cylinder axis may in particular be provided here as running in the radial direction of the tire.

In one embodiment, it is provided that the sensor module holders are respectively fastened on an inner side of a tire tread of the respective tire.

The fastening of the sensor module holders may in particular be obtained for example by adhesive bonding in the tire.

In one embodiment, it is provided that the tire monitoring system is designed as a tire pressure monitoring system, the sensor modules respectively detecting a pressure in the respective tire and (also) sending the tire pressure of the tire in question wirelessly to the receiving and evaluating device as a (further) operating parameter.

In this embodiment, therefore, not only an acceleration at the arrangement location of the sensor module is detected by sensors, but at least also the pressure in the tire in question.

As an alternative or in addition to the detection of the pressure in the respective tire, it may also be provided that the sensor modules respectively detect a temperature, for example in order to determine a tire temperature as a further operating parameter of the tire and to send it to the receiving and evaluating device in the vehicle.

In one embodiment, it is provided that the acceleration respectively detected by the sensors of the sensor modules at the arrangement location of the sensor module in question includes a radial acceleration and/or a tangential acceleration. As an alternative or in addition, the acceleration detected by the sensors may however also include at least one differently oriented acceleration or other type of acceleration (for example mechanical shock, vibration, etc.).

The detection of the radial acceleration has been found to be particularly advantageous for many applications (for example the determination of the rotational speed and/or length of a tire contact area and/or tire load).

In one embodiment, it is provided that the operating parameter respectively determined by the sensor modules is representative of a length of a tire contact area (footprint) of the tire in question.

In this sense, representative of the length of the tire contact area is for example an absolute measure of this length, but also for example a relative measure, which gives this length in relation to another variable that can be ascertained on the tire in question, for example a tire circumference or a tire diameter.

In one embodiment, the determined operating parameter gives the ratio of the length of the tire contact area to an outer circumference of the tire in question, hereinafter also referred to as the “tire contact quotient” (footprint quotient, FPQ).

In terms of measurement technology, the determination of the tire contact quotient in the sensor module in question can be obtained for example by the quotient being formed for this purpose from the time span which corresponds to the passage of the sensor module through the tire contact area and the time span which corresponds to a full tire revolution (360°).

In one embodiment, the relevant tire monitoring system is also used to determine wheel loads that act on the wheels and thus the tires of the vehicle.

For obtaining such a load monitoring functionality, the use (processing) of the aforementioned operating parameter which is representative of a length of a tire contact area, such as for example the aforementioned tire contact quotient, may for example be provided in particular.

When determining the wheel load on a particular tire, such an operating parameter may be processed for example together with the tire pressure determined for this tire and/or tire information relating to properties of the tire stored in the sensor module of this tire.

In one embodiment, the wheel load of the tire in question is determined and sent by the sensor module as a further operating parameter.

At very low vehicle speeds, for example less than about 10 km/h, speed-dependent effects of the centrifugal force acting on the sensor module tend to be negligible or only rather imprecisely ascertainable by measurement technology.

At very high vehicle speeds, for example greater than about 100 km/h, the centrifugal force is relatively great, but often even in this case only relatively small speed-dependent effects can be observed with regard to the discrepancy between the determined operating parameter and the operating parameter to be expected due to a certain saturation of the influence of the centrifugal force on the position and/or orientation of the sensor module.

In particular with respect to this aspect, it is provided according to one embodiment that the ascertainment of the discrepancy takes place in a predetermined partial range of an overall range of the speed of the vehicle that is operationally intended for the vehicle.

In one embodiment, the stated partial range is predetermined (for example fixed) with a lower limit, which may be for example at least 0 km/h, in particular at least 5 km/h, and for example at most 60 km/h, in particular at most 50 km/h.

In one embodiment, the stated partial range is predetermined (for example fixed) with an upper limit, which may be for example at most 150 km/h, in particular at most 100 km/h, and for example at least 60 km/h, in particular at least 70 km/h.

Such a focusing on only a partial range of vehicle speeds advantageously influences the quality or reliability of the intended detection.

In one embodiment of the invention, for determining the vehicle speed it is provided for example that the speed of the vehicle is based on a detection of the rotational speed of one or more of the vehicle wheels provided with the tires (for example averaging), each of these detections in turn being obtainable by a sensor device arranged on the vehicle wheel in question in the vehicle (for example a speed sensor) and/or on the basis of the sensor-based detection of the acceleration carried out by the sensor module in the tire of this vehicle wheel.

As an alternative or in addition to the detection of at least one such wheel rotational speed, a satellite-based position determining system (for example GPS) may also be used for detecting the vehicle speed.

In one embodiment, it is provided that the ascertainment of the discrepancy includes an ascertainment of a discrepancy that changes monotonically with varying speed of the vehicle.

In many cases, this measure also contributes to improving the quality of the stated detection. Since the explained influence of the centrifugal force acting speed-dependently on the sensor module suggests such a monotonic relationship, the ascertainment of such a monotony has a high informational value for the detection of the incorrect arrangement of the sensor module.

In principle, both the variant in which an increasing discrepancy as the vehicle speed increases is used as a criterion for the presence of an incorrect arrangement of the sensor module in question and the variant in which a decreasing discrepancy as the vehicle speed increases is used as such a criterion come into consideration for the ascertainment of a discrepancy changing monotonically with varying speed of the vehicle.

The latter variant, in which the ascertainment of a discrepancy that decreases as the speed increases is provided, is particularly well suited for detecting an incorrect arrangement of the sensor module that is common in practice, which consists in that the sensor module is slightly tilted and/or not properly (i.e. completely) held in a recessed manner in the sensor module holder in question.

In this frequent case, the tilting and the incorrect distance of the sensor module from the tire material lead to a falsification of the determined operating parameter, and therefore to a relatively great discrepancy between the operating parameter and the operating parameter to be expected, especially at relatively low vehicle speeds, whereas with increasing vehicle speed the sensor module tends to be righted and pressed closer up against the tire material or pressed into the sensor module holder due to the greater centrifugal force, whereby the discrepancy of the determined operating parameter becomes smaller or can no longer be ascertained as significant.

In the stated method, the detection of a faulty arrangement is preferably carried out in a parallel, i.e. essentially simultaneous or temporally overlapping, processing mode for all of the sensor modules of the tire monitoring system in question, with each individual sensor module being checked on the basis of the comparison of the operating parameters determined by all of the sensor modules as to whether the operating parameter for this sensor module shows a significant discrepancy with respect to the operating parameter to be expected for this sensor module and whether this discrepancy depends on the speed of the vehicle.

With respect to the latter aspect, it is understandable that, before the ascertainment of an incorrect arrangement of a sensor module, operating parameters determined for different vehicle speeds must first be collected (stored) and evaluated. As already explained above, it may be provided here to collect or evaluate the information in question only for an upwardly and/or downwardly limited partial range of vehicle speeds.

In one embodiment, the operating parameters used for the evaluation or detection of an incorrect arrangement are collected for at least three different speeds of the vehicle.

In one embodiment, for each speed of the vehicle predetermined by a detection algorithm, at least ten operating parameters or ten determination results of the operating parameter of each sensor module are collected for the evaluation or detection carried out for example by a statistical method.

In one embodiment, operating parameters are only collected in a predetermined range of driving dynamic states of the vehicle for the evaluation or detection of an incorrect arrangement. This range may for example provide that the vehicle is driving essentially straight ahead (for example transverse acceleration below a predetermined threshold) and/or is driving at an essentially constant speed (for example longitudinal acceleration below a predetermined threshold).

As far as the operating parameter to be expected that is to be determined for a particular sensor module is concerned, this determination may for example be performed on the basis of a predetermined mathematical model, which describes the operating parameter (tire operating parameter) for all of the sensor modules in dependence on one or more other operating parameters of the tires and/or the vehicle.

The mathematical model should expediently take into account a dependence of the operating parameters for the individual sensor modules at least on the individual tire pressures and on the individual wheel loads on the vehicle wheels provided with the tires. This is because different tire pressures and/or different wheel loads acting on the tires lead to different tire deformation states or tire geometries, which in turn lead to different variations over time of the sensor-detected accelerations when the tires roll on the road surface.

By means of the mathematical model, for example a plausibility check can be carried out for each sensor module as to whether or not the operating parameter determined by the sensor module is plausible in view of the operating parameters determined by the other sensor modules and whether a corresponding discrepancy of the operating parameter has a dependence on the vehicle speed specified by the mathematical model.

This will be explained using the example of a tire monitoring system with sensor modules, which determine in dependence on the sensor-recorded acceleration the operating parameter tire contact quotient (FPQ), defined as the ratio of a length of the tire contact area to the outer circumference of the tire in question, and measured by the sensor module for example as the ratio between a time span for the passage of the sensor module through the footprint to the time span for a full wheel revolution.

Also assuming that the vehicle is a two-track four-wheeled vehicle with four identical tires, in which the tire pressure is identical and on which an identical wheel load acts, the vehicle traveling straight ahead at constant speed. It is then to be expected that the operating parameter determined by the individual sensor modules (here: FPQ) is identical for all of the sensor modules.

When checking for a discrepancy of the operating parameter of a particular sensor module, in this situation a mean value (for example an arithmetic mean value) of the operating parameters of the other three sensor modules may be used for example as the operating parameter to be expected. If it is ascertained for a particular sensor module that there is a discrepancy, dependent on the speed of the vehicle, between the operating parameter and this operating parameter to be expected, this can accordingly be assessed as a faulty arrangement of this sensor module in the sensor module holder in question.

If the above requirements, such as for example identical tire pressures, identical wheel loads, etc. are not met, a mathematical model used to determine the operating parameter to be expected can take this into account (model it) in an appropriate manner.

In this regard, it can for example be taken into account that a lower tire pressure in a particular tire (sensor-detected by the sensor module in question) leads to a greater tire contact quotient for this tire. It can similarly be taken into account for example that, when the vehicle is driving around a curve, the tire contact quotients of the tires on the outside of the curve are increased and the tire contact quotients of the tires on the inside of the curve are reduced, also dependent on the vehicle speed.

In a preferred embodiment, the operating parameter to be expected for a particular sensor module is determined on the basis of an averaging of normalized operating parameters of the other sensor modules, the normalization being provided in such a way that the physical influences still remaining even when all of the sensor modules are properly arranged in the sensor module holders due to different tire pressures and/or different wheel loads and/or the influence of the driving state (speed, road inclination, steering angle, etc.) can thus be compensated.

In one embodiment, the operating parameter to be expected is determined on the basis of the aforementioned mathematical model, this model also taking into account a dependence of the operating parameters for the individual sensor modules on the speed of the vehicle. For example, in this way an incorrect arrangement of the sensor module could be ascertained by finding that the speed dependence of the operating parameter determined by this sensor module is significantly different from the speed dependence expected according to the model and/or the speed dependence observed for the other tires.

In one embodiment of the invention, it is provided that the detection of the incorrect arrangement is carried out in a program-controlled manner, it being possible for this to be expediently obtained by means of the receiving and evaluating device of the tire monitoring system in question.

If the receiving and evaluating device of the tire monitoring system does not itself determine the current speed of the vehicle (for example on the basis of the sensor-detected accelerations at arrangement locations of the sensor modules), it may be provided that information about the current vehicle speed is communicated to the receiving and evaluating device by others parts of a vehicle's electronics (for example wheel sensors and/or a GPS device).

Another aspect of the present invention relates to a tire monitoring system for a vehicle, comprising:
multiple sensor modules which can be arranged in a respective sensor module holder of a respective tire of a vehicle and are respectively designed to determine and wirelessly send an operating parameter of the tire in question in dependence on a sensor-detected acceleration at the arrangement location of the sensor module, and
a receiving and evaluating device which can be arranged in the vehicle for receiving and evaluating the operating parameters of the tires sent by the sensor modules, the receiving and evaluating device also being designed to detect a faulty arrangement of a sensor module of the multiple sensor modules in the sensor module holder in question by ascertaining on the basis of a comparison of the operating parameters determined by the sensor modules that there is for this sensor module a discrepancy, dependent on the speed of the vehicle, between the operating parameter and an operating parameter to be expected for this sensor module.

The embodiments and special configurations described for the detection method according to the first aspect of the invention can also be provided, individually or in any combination, in a corresponding manner as embodiments or special configurations of the tire monitoring system according to the further aspect of the invention and vice versa.

The invention is described in more detail below on the basis of exemplary embodiments with reference to the accompanying drawings, in which:

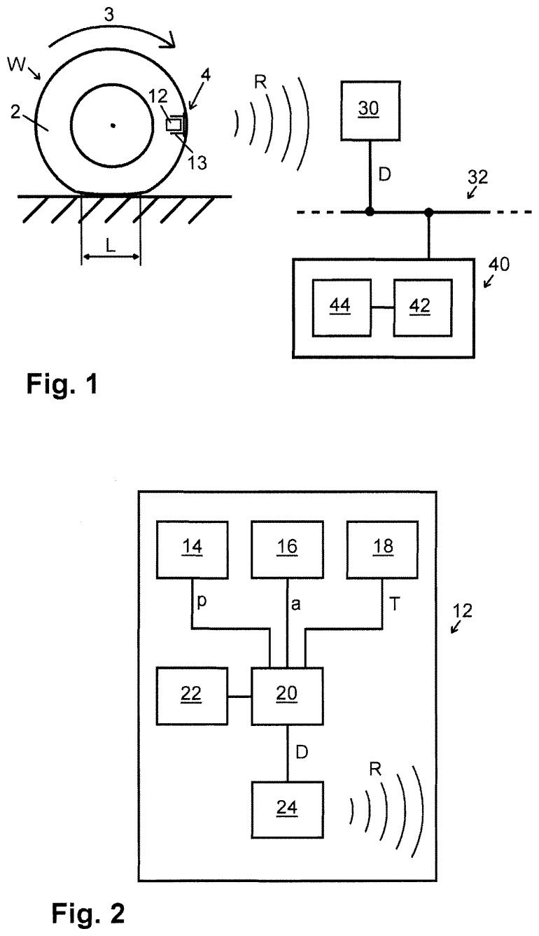

FIG. 1 shows a schematic side view of a vehicle wheel with a tire in which a sensor module held in a sensor module holder is arranged,

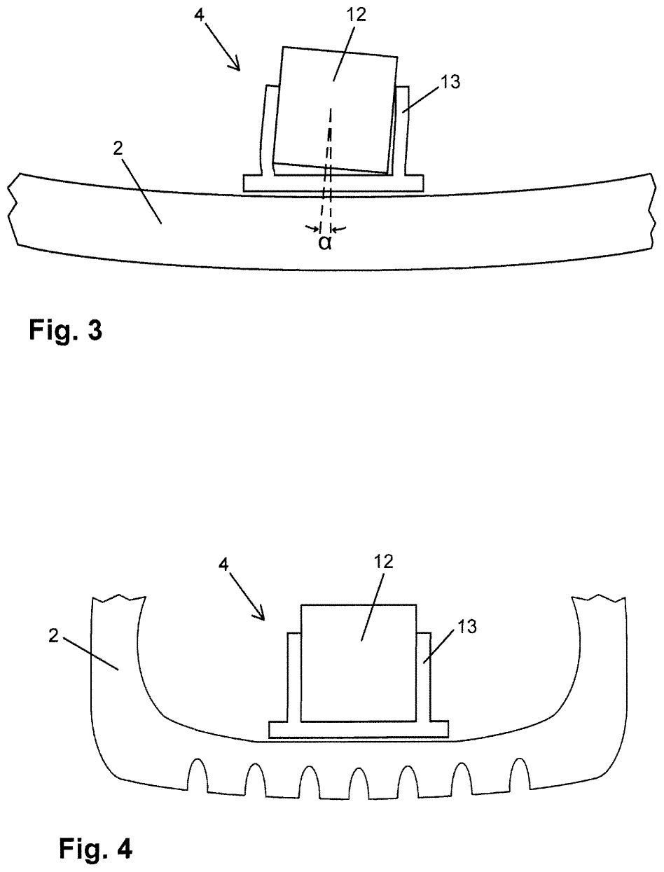

FIG. 2 shows a block diagram of the sensor module from FIG. 1,

FIG. 3 shows a schematic side view of a detail of the tire from FIG. 1 to illustrate a faulty arrangement of the sensor module in the sensor module holder,

FIG. 4 shows a further schematic view (cross section) of the detail from FIG. 3,

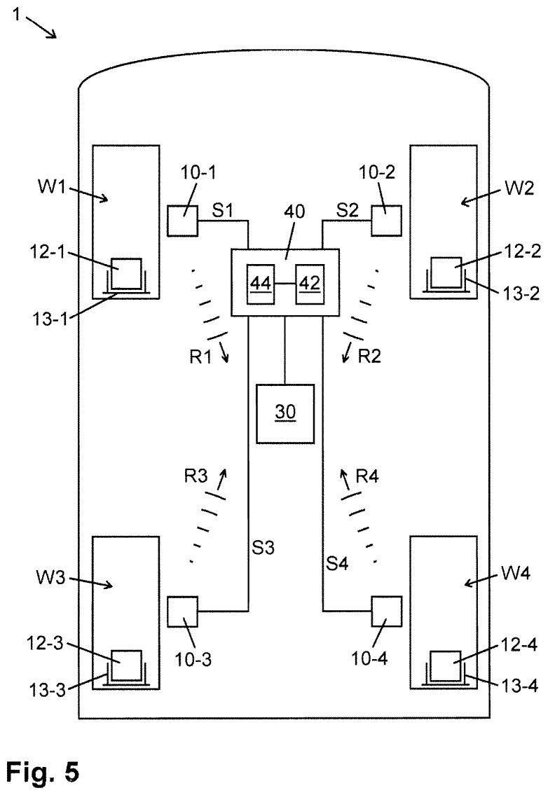

FIG. 5 shows a schematic plan view of a vehicle equipped with a tire monitoring system and

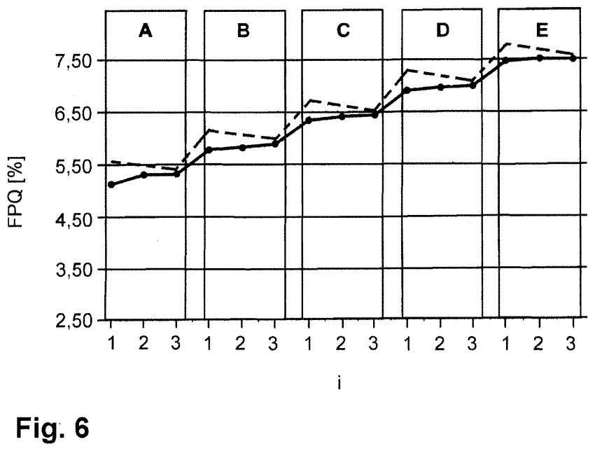

FIG. 6 shows a representation to illustrate the effect of a faulty arrangement of a sensor module on a tire contact quotient determined by means of this sensor module.

FIG. 1 shows a vehicle wheel W having a rim and a tire 2 mounted on the rim. A rotation of the tire 2 while the vehicle in question is traveling is symbolized by an arrow 3.

In the tire 2, a sensor module 12 is arranged in a sensor module holder 13 as a component of a tire monitoring system of the vehicle in question, the sensor module holder 13 being designed as a receptacle made of an elastic material (for example rubber) in which the sensor module 12 is inserted.

In the exemplary embodiment shown, the sensor module holder 13 delimits a cylindrical receiving space in order to receive a correspondingly cylindrically shaped body of the sensor module 12 in it and to fix it by the elastic enclosure of the sensor module body. In this example, the sensor module holder 13 is adhesively bonded on an inner side of a tire tread of the tire 2.

When the vehicle is being driven, the sensor module 12 determines for example in particular an operating parameter which is representative of a length L indicated in FIG. 1 of a tire contact area of the tire 2.

FIG. 2 shows a block diagram of the sensor module 12, having a pressure sensor 14 for detecting a pressure sensor signal “p” representative of a pressure in the tire 2, an acceleration sensor 16 for detecting an acceleration sensor signal “a” representative of an acceleration, in the exemplary embodiment shown the radial acceleration, and a temperature sensor 18 for detecting a temperature sensor signal “T” representative of a temperature inside the tire 2.

The sensor module 12 also has a program-controlled control device 20 (for example a microcontroller) with an associated memory device 22 for storing a program that controls the operation of the control device 20. The control device 20 receives the aforementioned sensor signals p, T, a and, in dependence on these sensor signals, determines in a program-controlled manner multiple tire operating parameters, which are recorded from time to time in a data message D generated by the control device 20 and sent by means of a radio transmitting device 24 in the form of radio transmissions R to a radio receiving device 30 arranged in the vehicle and likewise shown in FIG. 1 and passed on from there to an evaluating device 40.

In this exemplary embodiment, a receiving and evaluating device is thus formed by the radio receiving device 30 for receiving and decoding the radio transmissions R and the evaluating device 40, which receives the data messages D decoded by the radio receiving device 30 via a digital bus system 32 (for example CAN bus, LIN bus or the like) and then evaluates them or passes on information obtained from them to other parts of the vehicle's electronics.

In the example shown, the evaluating device 40 is formed by a program-controlled computer unit 42 and an assigned memory unit 44 for storing a program that controls the operation of the computer unit 42. In practice, the evaluating device 40 may for example also be implemented as a partial functionality of a central control device (ECU) that is in any case present in the vehicle in question.

In the example shown, in particular the tire pressure, the tire temperature, the rotational speed and a tire contact quotient FPQ of the tire 2 are provided as tire operating parameters of the tire 2 which are transmitted to the receiving and evaluating device by means of the radio transmissions D.

Here, the tire pressure and the tire temperature are determined directly on the basis of the corresponding sensor signals “p” and “T”, whereas the determination of the rotational speed and the tire contact quotient FPQ is based on an evaluation carried out by the control device 20 of the variation over time of the sensor signal “a” representative of the radial acceleration at an arrangement location 4 of the sensor module 12.

To determine the rotational speed, there is the possibility for example of evaluating the gravitational component of the sensor signal “a” periodically changing with each wheel revolution or for example the possibility of evaluating the frequency of the occurrence of signal characteristics in the sensor signal “a” that occur with each passage of the arrangement location 4 through the footprint (the tire contact area). This also allows determination of the tire contact quotient FPQ, which is defined here as the quotient between the length L indicated in FIG. 1 of the tire contact area and the total circumference of the tire 2.

Every time the sensor module 12 makes impact on entering the tire contact area and every time the sensor module 12 lifts off on leaving the tire contact area, typical signal characteristics appear in the sensor signal “a”, so that the operating parameter FPQ can be calculated as the quotient between the time span between impact and lifting off and the time span of a complete revolution (360°) of the tire 2.

In addition to the operating parameters already mentioned, still further operating parameters can be determined by the control device 20 in dependence on the sensor-detected variables and transmitted to the receiving and evaluating device.

FIGS. 3 and 4 again illustrate on the basis of enlarged (not to scale) representations the arrangement of the sensor module 12 in the sensor module holder 13 at the arrangement location 4 in the tire 2.

Illustrated here in FIG. 3 is a faulty arrangement of the sensor module 12 in the sensor module holder 13, which cannot be ruled out in practice. In this example, the sensor module 12, viewed in the circumferential direction of the tire 2, is arranged somewhat tilted (with an angle of inclination α).

Such an incorrect arrangement of the sensor module 12 is generally not a problem for determining the tire pressure and the tire temperature. However, in principle this incorrect arrangement can in particular falsify all of the operating parameters determined by the sensor module 12 in dependence on the detected acceleration (signal “a”), such as here in particular the determined tire contact quotient FPQ. The inclined sensor module 12 is no longer able to detect the radial acceleration as actually intended, but in the situation shown in fact detects an oriented acceleration at the arrangement location 4 that is somewhat inclined with respect to the radial direction.

The incorrect arrangement of the sensor module 12 illustrated in FIG. 3 leads to a falsification of the result of the sensory detection of the radial acceleration. This fault case thus also affects the function and reliability of the tire monitoring system in which such an incorrectly installed sensor module 12 is integrated.

The present invention aims to detect an incorrect arrangement of a sensor module as shown for example in FIG. 3, so that for example operating parameters supplied by the sensor module in question may be assessed by the receiving and evaluating device as completely or partially invalid and/or may be excluded from further use.

Illustrated by contrast in FIG. 4 is a faultless or correct arrangement of the sensor module 12 in the sensor module holder 13.

FIG. 5 shows a vehicle 1 equipped with a tire monitoring system according to one embodiment, which in the example shown is a two-track four-wheeled motor road vehicle (for example a car) with two front wheels W1, W2 and two rear wheels W3, W4. The wheels W1 to W4 are respectively fitted with a tire in which a sensor module 12-1, 12-2, 12-3 or 12-4 is arranged. The associated sensor module holders are designated in FIG. 5 by the reference numerals 13-1 to 13-4.

In the following description of the tire monitoring system of FIG. 5, it will be assumed that each of the vehicle wheels W1 to W4 is designed as already described with reference to FIGS. 1 to 4 for the vehicle wheel W (FIG. 1), and therefore each of the sensor modules 12-1 to 12-4 together with the associated sensor module holders 13-1 to 13-4 are also designed and function as already described with reference to FIGS. 1 to 4 for components 12 and 13.

The tire monitoring system used in the vehicle 1 includes the sensor modules 12-1 to 12-4, which are respectively arranged in an assigned sensor module holder of the sensor module holders 13-1 to 13-4 of the respective tire of the vehicle 1, not shown in FIG. 5, and are respectively designed to determine in dependence on inter alia the sensor-detected acceleration (here the radial acceleration) multiple operating parameters of the tire in question, including in particular the tire contact quotient FPQ, and to send them wirelessly (as radio transmissions R1 to R4).

The tire monitoring system also includes the receiving and evaluating device arranged in the vehicle 1 for receiving and evaluating the operating parameters sent by the sensor modules 12-1 to 12-4.

The receiving and evaluating device, here consisting of the radio receiving device 30 and the program-controlled evaluating device 40 connected to it via the communication bus 32, is designed to detect a faulty arrangement of one of the sensor modules 12-1 to 12-4 (cf. for example FIG. 3) in the sensor module holder 13-1, 13-2, 13-3 or 13-4 in question by ascertaining on the basis of a comparison of the tire contact quotients FPQ determined by all of the sensor modules 12-1 to 12-4 that there is for this sensor module a discrepancy, dependent on the speed of the vehicle 1, between the tire contact quotient FPQ and a tire contact quotient FPQ to be expected for this sensor module.

In this detection, a kind of plausibility check for example may be carried out in such a way that it is respectively checked for each of the sensor modules 12-1 to 12-4 whether or not the FPQ value supplied by the sensor module in question is plausible in view of the FPQ values supplied by the other three sensor modules. In the case of an ascertained implausibility, equivalent to a significant discrepancy (for example lying above a predetermined threshold) between the FPQ value and an FPQ value to be expected with a proper sensor module arrangement, this is assessed as an incorrect arrangement of the sensor module in question in the case where the discrepancy is dependent on the speed of the vehicle 1.

To determine the speed of the vehicle 1, in the exemplary embodiment shown, wheel sensors (speed sensors) 10-1 to 10-4 installed in the vehicle in a manner respectively assigned to one of the wheels W1 to W4 are used. Sensor signals S1 to S4 supplied by these wheel sensors 10-1 to 10-4 are transmitted here in a wired manner (for example using the digital bus system 32) to the evaluating device 40, which determines the current vehicle speed from them.

On the basis of the knowledge of the current vehicle speed, the evaluating device 40 continuously collects data while the vehicle 1 is being driven, including the FPQ values supplied by the sensor modules 12-1 to 12-4, in each case in association with a relevant identification of the supplying sensor module (for example encoded in the respective radio transmission R1, R2, R3 or R4) and in association with the speed of the vehicle 1 applicable at the point in time in question. The explained detection is carried out by the evaluating device 40 on the basis of these data.

If, for example, the sensor module 12-4 installed in the wheel W4 is incorrectly arranged and the plausibility of the FPQ value supplied by the sensor module 12-4 is checked as part of the detection method, the evaluating device 40 can use the data collected for different vehicle speeds to ascertain for example a discrepancy between the FPQ value and an FPQ value to be expected. The FPQ value to be expected can be determined for example according to a predetermined algorithm, running in the evaluating device 40, for example from the FPQ values supplied by the other sensor modules 12-1 to 12-3. Before a final ascertainment of the incorrect arrangement, however, a check is also made here as to whether or not the ascertained discrepancy is dependent on the vehicle speed in a manner defined by the detection method (for example discrepancy increases/decreases as the vehicle speed increases).

FIG. 6 illustrates by way of example the effect of an incorrect arrangement of a sensor module on the FPQ value determined by this sensor module.

In FIG. 6, the FPQ value is plotted in the upward direction. The FPQ values represented by dots or a solid line are those of a properly arranged sensor module. By contrast, the dashed line illustrates the FPQ values of a sensor module incorrectly arranged in the same driving situation.

In FIG. 6, the five partial representations “A” to “E” initially illustrate the dependence of the FPQ value on a wheel load currently acting on the tire in question. The individual partial diagrams A to E are based on the following wheel loads: 525 kg (A), 600 kg (B), 675 kg (C), 750 kg (D) and 825 kg (E). It can be seen from this that the greater the wheel load, the greater the FPQ value.

Within each of the partial diagrams A to E, three results are respectively given for the FPQ value, characterized by an index i with i=1, 2 or 3, the index i being representative of the vehicle speed in question as follows: 40 km/h (i=1), 60 km/h (i=2) and 90 km/h (i=3). It can be seen from this that, in the example shown for the properly arranged sensor module, there is a certain dependence of the FPQ value on the vehicle speed. In the example shown, the FPQ value tends to increase somewhat as the vehicle speed increases.

For the FPQ value of the incorrectly arranged sensor module (dashed line), on the other hand, there is a significant discrepancy with respect to the FPQ value to be expected (solid line), this discrepancy being dependent on the vehicle speed. In the example shown, irrespective of the wheel load, the discrepancy in the observed speed range from 40 km/h to 90 km/h decreases monotonically as the vehicle speed increases.

In the example shown, this discrepancy is relatively great at a speed of 40 km/h (i=1) and almost zero at a speed of 90 km/h (i=3).

Transferred to the exemplary embodiment of a tire monitoring system shown in FIG. 5, in this tire monitoring system it may be provided for example that, in the partial range of 40 km/h to 90 km/h of the vehicle speed for the sensor module in question, an FPQ value decreasing monotonically as the vehicle speed increases is obtained as a criterion for the ascertainment of an incorrectly arranged sensor module (12-1, 12-2, 12-3 or 12-4).

### LIST OF REFERENCE SIGNS

1 Vehicle
W Vehicle wheel
2 Tire
3 Arrow
4 Arrangement location
L Length of the tire contact area
FPQ Tire contact quotient
10-1 Wheel sensor
10-2 Wheel sensor
10-3 Wheel sensor
10-4 Wheel sensor
12 Sensor module
13 Sensor module holder
14 Pressure sensor
p Pressure sensor signal
16 Acceleration sensor
a Acceleration sensor signal
18 Temperature sensor
T Temperature sensor signal
20 Control device
22 Memory device
24 Radio transmitting device
D Data message
R Radio transmissions
30 Radio receiving device
32 Bus system
40 Evaluating device
42 Computer unit
44 Memory unit

1. A method for detecting a faulty arrangement of a sensor module in a sensor module holder in a tire of a vehicle equipped with a tire monitoring system,
the tire monitoring system having multiple sensor modules arranged in a respective sensor module holder of a respective tire of the vehicle, which respectively determine in dependence on a sensor-detected acceleration at an arrangement location of the sensor module an operating parameter of the tire in question and send it wirelessly to a receiving and evaluating device arranged in the vehicle,
with a detection of a faulty arrangement of a sensor module of the sensor modules in the sensor module holder in question being performed by: ascertaining based on a comparison of the operating parameters determined by the sensor modules that there is for this sensor module a discrepancy, dependent on a speed of the vehicle, between the operating parameter and an operating parameter to be expected for this sensor module.

2. The method as claimed in claim 1, the sensor module holders being respectively designed as a receptacle formed from an elastic material for inserting the respective sensor module.

3. The method as claimed in claim 1, the sensor module holders being respectively fastened on an inner side of a tire tread of the respective tire.

4. The method as claimed in claim 1, the tire monitoring system configured to be a tire pressure monitoring system, the sensor modules respectively detecting a pressure in the respective tire and sending tire pressure information wirelessly to the receiving and evaluating device as an operating parameter of the tire in question.

5. The method as claimed in claim 1, the acceleration respectively detected by the sensors of the sensor modules at the arrangement location of the sensor module in question including at least one of a radial acceleration and a tangential acceleration.

6. The method as claimed in claim 1, the operating parameter respectively determined by the sensor modules being representative of a length of a tire contact area of the tire in question.

7. The method as claimed in claim 6, the operating parameter respectively determined by the sensor modules giving a ratio of the length of the tire contact area to an outer circumference of the tire in question.

8. The method as claimed in claim 1, the ascertainment of the discrepancy taking place in a predetermined partial range of an overall range of the speed of the vehicle that is operationally intended for the vehicle.

9. The method as claimed in claim 1, the ascertainment of the discrepancy including an ascertainment of a discrepancy that changes monotonically with varying speed of the vehicle.

10. A tire monitoring system for a vehicle, comprising
multiple sensor modules configured to be arranged in a respective sensor module holder of a respective tire of a vehicle and are respectively configured to determine and wirelessly send an operating parameter of the tire in question in dependence on a sensor-detected acceleration at an arrangement location of the sensor module,
a receiving and evaluating device configured to be arranged in the vehicle and further configured to receiver and evaluate the operating parameters of the tires sent by the sensor modules,
the receiving and evaluating device further configured to detect a faulty arrangement of a sensor module of the sensor modules in the sensor module holder in question by ascertaining based on a comparison of the operating parameters determined by the sensor modules that there is for this sensor module a discrepancy, dependent on a speed of the vehicle, between the operating parameter and an operating parameter to be expected for this sensor module.

11. The tire monitoring system as claimed in claim 10, the operating parameter respectively determined by the sensor modules being representative of a length of a tire contact area of the tire in question.

12. The tire monitoring system as claimed in claim 11, the operating parameter respectively determined by the sensor modules giving a ratio of the length of the tire contact area to an outer circumference of the tire in question.

13. The tire monitoring system as claimed in claim 10, the ascertainment of the discrepancy taking place in a predetermined partial range of an overall range of the speed of the vehicle that is operationally intended for the vehicle.

14. The tire monitoring system as claimed in claim 10, the ascertainment of the discrepancy including an ascertainment of a discrepancy that changes monotonically with varying speed of the vehicle.
